(19) United States
(12) Patent Application Publication
(10) Pub. No.: US 2025/0189812 A1
(43) Pub. Date: Jun. 12, 2025

(54) LIGHT GUIDE PLATE AND IMAGE DISPLAY DEVICE

(71) Applicant: SONY GROUP CORPORATION, Tokyo (JP)

(72) Inventors: Kazue SHIMIZU, Tokyo (JP); Christophe PEROZ, Tokyo (JP); Nobuhiro KIHARA, Tokyo (JP)

(73) Assignee: SONY GROUP CORPORATION, Tokyo (JP)

(21) Appl. No.: 18/841,006

(22) PCT Filed: Feb. 15, 2023
(86) PCT No.: PCT/JP2023/005149

§ 371 Date: Aug. 23, 2024

(30) Foreign Application Priority Data
Mar. 7, 2022 (JP) 2022-034256

(51) Int. Cl. G02B 27/42; G02B 27/01

(52) U.S. Cl. CPC G02B 27/4205; G02B 27/0172; G02B 27/4272

(57) ABSTRACT

To improve the uniformity in the intensity of light to be emitted, by varying the thickness of a residual layer. There is provided a light guide plate including: an incidence portion that diffracts incident light into the light guide plate; a substrate that internally totally reflects the light diffracted into the light guide plate by the incidence portion and guides the light; and an emission portion that diffracts the light guided by the substrate and emits the light to a pupil of an observer, in which: the emission portion includes a diffraction grating; and a residual layer thickness as a thickness of a residual layer formed between the diffraction grating of the emission portion and the substrate is determined such that a light intensity as an intensity of the light emitted from the emission portion is substantially uniform.

### TECHNICAL FIELD

The present technique relates to a light guide plate and an image display device.

### BACKGROUND ART

There has conventionally been developed a light guide plate that emits image light to the pupils of an observer, in order to implement Extended Reality (XR) including Augmented Reality (AR), Virtual Reality (VR), Mixed Reality (MR), and so forth.

In this light guide plate, a diffraction grating is used to diffract the image light and emit the diffracted image light to the pupils. When the diffraction grating is formed by a nanoimprint method, for example, a residual layer is formed between the diffraction grating and a substrate. The formation of the residual layer is disclosed in PTL 1 and PTL 2, for example.

### CITATION LIST

### Patent Literature

PTL 1: WO 2018/039273
PTL 2: WO 2020/185954

### SUMMARY

### Technical Problem

PTL 1 indicates that the residual layer is generally formed to be thin and uniform. PTL 2 indicates that the height of the diffraction grating is varied, but does not indicate or suggest that the thickness of the residual layer is varied.

Thus, it is a main object of the present technique to provide a light guide plate and an image display device that improve the uniformity in the intensity of light to be emitted, by varying the thickness of a residual layer.

### Solution to Problem

The present technique provides a light guide plate including: an incidence portion that diffracts incident light into the light guide plate; a substrate that internally totally reflects the light diffracted into the light guide plate by the incidence portion and guides the light; and an emission portion that diffracts the light guided by the substrate and emits the light to a pupil of an observer, in which: the emission portion includes a diffraction grating; and a residual layer thickness as a thickness of a residual layer formed between the diffraction grating of the emission portion and the substrate is determined such that a light intensity as an intensity of the light emitted from the emission portion is substantially uniform.

A refractive index of the diffraction grating may be determined such that the light intensity is substantially uniform.

The refractive index may become higher toward substantially a center of the emission portion from the incidence portion.

A height of the diffraction grating may be determined such that the light intensity is substantially uniform.

The height may become higher toward substantially a center of the emission portion from the incidence portion.

The residual layer thickness may become smaller toward substantially a center of the emission portion from the incidence portion.

A height of the diffraction grating may become higher toward substantially the center of the emission portion from the incidence portion.

The residual layer thickness may become greater toward substantially a center of the emission portion from the incidence portion.

The refractive index may become higher toward substantially the center of the emission portion from the incidence portion.

A height of the diffraction grating may become higher toward substantially the center of the emission portion from the incidence portion.

The residual layer thickness may become smaller toward a side opposite to the incidence portion from substantially the center of the emission portion.

Path lengths for two lights from a point at which light is diffracted by the diffraction grating into two lights to a point at which the two lights are merged with each other may meet a mathematical expression indicated by the formula (5); and when a wavelength of the incident light is defined as λ, a side-view incident angle is defined as ϕ, and a refractive index of the diffraction grating is defined as n, an allowable residual layer thickness Δt may meet the mathematical expression indicated by the formula (5).

$$Δ t < λ cos ϕ / 4 n \qquad ( 5 )$$

The allowable residual layer thickness Δt may meet a mathematical expression indicated by the formula (6).

$$Δ t < λcosϕ / 8 n \qquad ( 6 )$$

The light guide plate may further include an expansion portion that diffracts the light guided by the substrate toward the emission portion and expands the light; the expansion portion may include a diffraction grating; and a residual layer thickness as a thickness of a residual layer formed between the diffraction grating of the expansion portion and the substrate may be determined such that a light intensity as an intensity of the light emitted from the emission portion is substantially uniform.

The light guide plate may further include a return portion that diffracts the light inward of the emission portion; the return portion may be disposed on an outer side of a region on which light from the substrate is incident, and at an outer periphery of the emission portion; the return portion may include a diffraction grating; and a residual layer thickness as a thickness of a residual layer formed between the diffraction grating of the return portion and the substrate may be determined such that a light intensity as an intensity of the light emitted from the emission portion is substantially uniform.

The incidence portion may include a diffraction grating; and a residual layer thickness as a thickness of a residual layer formed between the diffraction grating of the incidence portion and the substrate may be determined such that a light intensity as an intensity of the light emitted from the emission portion is substantially uniform.

The emission portion may be disposed on one or both surfaces of the light guide plate.

The light guide plate may include: one or a plurality of incidence portions; and one or a plurality of emission portions.

The present technique also provides an image display device including: the light guide plate; and an image formation unit that emits image light to the light guide plate.

According to the present technique, it is possible to provide a light guide plate and an image display device that improve the uniformity in the intensity of light to be emitted, by varying the thickness of a residual layer. The effects described here are not necessarily limited and may be any of the effects described in the present disclosure.

### BRIEF DESCRIPTION OF DRAWINGS

FIG. 1 is a simplified front view illustrating a configuration example of a light guide plate 1 according to an embodiment of the present technique.

FIG. 2 illustrates a configuration example of the light guide plate 1 according to the embodiment of the present technique.

FIG. 3 is a schematic diagram illustrating an example of a method of manufacturing the light guide plate 1 according to the embodiment of the present technique.

FIG. 4 is a simplified side view illustrating a configuration example of the light guide plate 1 according to the embodiment of the present technique.

FIG. 5 is a graph indicating the correlation between the penetration depth of evanescent light and the side-view incident angle of light.

FIG. 6A is a simplified front view illustrating a configuration example of the light guide plate 1 according to the embodiment of the present technique. FIGS. 6B and 6C are each a graph indicating a design example of an emission portion 4 according to the embodiment of the present technique.

FIG. 7 illustrates an example of the light guide plate 1 according to the embodiment of the present technique.

FIG. 8 is a graph indicating a simulation result of the emission portion 4 according to the embodiment of the present technique.

FIG. 9 illustrates an example of the light guide plate 1 according to an embodiment of the present technique.

FIG. 10 illustrates an example of an emission portion 4 according to an embodiment of the present technique.

FIG. 11 is a simplified perspective view illustrating how light is guided inside a light guide plate 1 according to an embodiment of the present technique.

FIG. 12 is a simplified front view illustrating how light is guided inside the light guide plate 1 according to the embodiment of the present technique.

FIG. 13 is a simplified front view illustrating how light is guided inside an emission portion 4 according to the embodiment of the present technique.

FIG. 14 is a graph indicating the correlation between a number n_{bou} of bounces and the diffraction efficiency.

FIG. 15 is a simplified side view illustrating a configuration example of the light guide plate 1 according to the embodiment of the present technique.

FIG. 16 is a simplified side cross-sectional view illustrating a configuration example of a light guide plate 1 according to an embodiment of the present technique.

FIG. 17 is a simplified side cross-sectional view illustrating a configuration example of a light guide plate 1 according to an embodiment of the present technique.

FIG. 18 is a simplified front view illustrating a configuration example of an incidence portion 2 and an emission portion 4 according to an embodiment of the present technique.

FIG. 19 is a block diagram illustrating a configuration example of an image display device 10 according to an embodiment of the present technique.

### DESCRIPTION OF EMBODIMENTS

The following is a description of preferable embodiments for implementing the present technique with reference to the drawings. The embodiments which will be described below show an example of representative embodiments of the present technique, and the scope of the present technique should not be limited on the basis of these embodiments. Furthermore, any of the following examples and modifications thereof may be combined in the present technique.

In the description of the embodiments below, configurations may be described using terms with “substantially,” such as substantially parallel or substantially orthogonal. For example, the term “substantially parallel” means not only fully parallel but also practically parallel; that is, the term includes a state that deviates from a completely parallel state by, for example, a few percent. The same applies to other terms with “substantially.” Furthermore, the drawings are schematic diagrams and are not necessarily exact illustrations.

In the drawings, unless otherwise specified, “up” means the upper direction or the upper side in the drawing, “down” means the lower direction or the lower side in the drawing, “left” means the left direction or the left side in the drawing, and “right” means the right direction or the right side in the drawing. Also, the same reference signs will be given to the same or equivalent elements or members in the drawings, and redundant descriptions thereof will not be given.

Description will be given in the following order.
1. First Embodiment (Example 1 of Light Guide Plate)
(1) Overview
(2) Adjustment of Height of Diffraction Grating
(3) Residual Layer Thickness
(4) Adjustment of Residual Layer Thickness
2. Second Embodiment (Example 2 of Light Guide Plate)
3. Third Embodiment (Example 3 of Light Guide Plate)
4. Fourth Embodiment (Example 4 of Light Guide Plate)
5. Fifth Embodiment (Example 5 of Light Guide Plate)
6. Sixth Embodiment (Example 6 of Light Guide Plate)
7. Seventh Embodiment (Example 7 of Light Guide Plate)
8. Eighth Embodiment (Example of Image Display Device)

### 1. First Embodiment (Example 1 of Light Guide Plate)

### (1) Overview

The present technique provides a light guide plate including: an incidence portion that diffracts incident light into the light guide plate; a substrate that internally totally reflects the light diffracted into the light guide plate by the incidence portion and guides the light; and an emission portion that diffracts the light guided by the substrate and emits the light to a pupil of an observer, in which: the emission portion includes a diffraction grating; and a residual layer thickness as a thickness of a residual layer formed between the diffraction grating of the emission portion and the substrate is determined such that a light intensity as an intensity of the light emitted from the emission portion is substantially uniform.

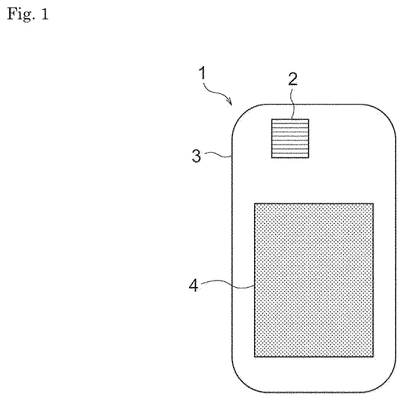

A light guide plate according to an embodiment of the present technique will be described with reference to FIG. 1. FIG. 1 is a simplified front view illustrating a configuration example of a light guide plate 1 according to an embodiment of the present technique. As illustrated in FIG. 1, a light guide plate 1 according to an embodiment of the present technique includes an incidence portion 2 that diffracts incident light into the light guide plate 1, a substrate 3 that guides the light diffracted into the light guide plate 1 by the incidence portion 2 through internal total reflection, and an emission portion 4 that diffracts the light guided by the substrate 3 and emits the diffracted light to the pupils of an observer. The incidence portion 2 and the emission portion 4 include a diffraction grating. A surface relief diffraction grating (SRG: Surface Relief Grating), a volume phase holographic diffraction grating (VPHG: Volume Phase Holographic Grating), and so forth can be used as the incidence portion 2 and the emission portion 4, for example. When a volume phase holographic diffraction grating is used, a plurality of diffraction gratings may be formed on the same surface, or a plurality of diffraction gratings may be stacked on each other. In the following description, a surface relief diffraction grating is used as an example of the incidence portion 2 and the emission portion 4.

Incident light from an image formation unit (not illustrated) that forms image light is diffracted into the light guide plate 1 by the incidence portion 2. The light diffracted into the light guide plate 1 is totally reflected by the substrate 3 inside the light guide plate 1 to be led to the emission portion 4. The emission portion 4 widens the led light outward, returns the light inward, and emits the light to the pupils of an observer. The incidence portion 2 and the emission portion 4 may not be physically away from each other.

It is preferable to emit image light with a substantially uniform light intensity to the pupils of an observer disposed in an eye box, in order to provide the observer with a high-efficiency and high-quality image.

However, there is a problem that a light loss occurs and the light intensity decreases while light is guided inside the substrate 3 and emitted to the pupils of an observer by the emission portion 4. The amount of the light loss increases and the light intensity decreases as the light path is longer.

Therefore, the diffraction efficiency is preferably varied in accordance with the position at which the diffraction grating is disposed. In particular, the diffraction efficiency preferably becomes higher as the distance from the incidence portion 2 becomes longer. This makes it possible to render the light intensity of light emitted to the pupils of an observer substantially uniform.

### [(2) Adjustment of Height of Diffraction Grating]

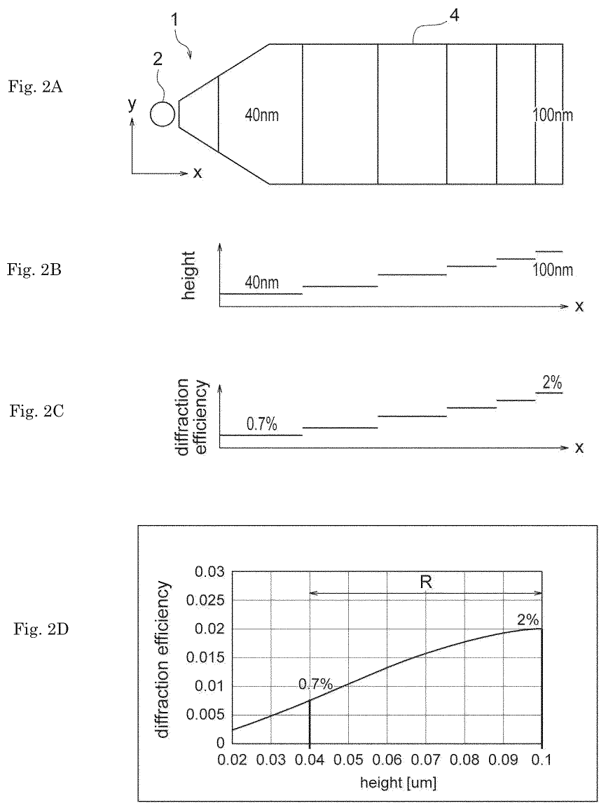

The diffraction efficiency can be varied by varying the height of the diffraction grating of the emission portion 4, for example. This will be described with reference to FIG. 2. FIG. 2 illustrates a configuration example of the light guide plate 1 according to the embodiment of the present technique.

FIG. 2A is a simplified front view illustrating a configuration example of the light guide plate 1. As illustrated in FIG. 2A, the light guide plate 1 includes an incidence portion 2 and an emission portion 4.

FIG. 2B is a graph indicating how the height of the diffraction grating of the emission portion 4 varies. The horizontal axis indicates a distance x from the incidence portion 2. The horizontal axis corresponds to FIG. 2A. The vertical axis indicates the height of the diffraction grating. In this configuration example, the height of the diffraction grating increases discretely from 40 nm to 100 nm as the distance x from the incidence portion 2 becomes longer.

In this configuration example, the residual layer thickness as the thickness of a residual layer formed between the diffraction grating and the substrate 3 is 0 nm. The width of the diffraction grating is 150 nm. The pitch as the interval of periodic structures (such as slits, for example) of the diffraction grating is 320 nm. The extinction coefficient of the diffraction grating is 0. The refractive index of the diffraction grating is 1.5.

FIG. 2C is a graph indicating the diffraction efficiency obtained through simulations. The horizontal axis indicates the distance x from the incidence portion 2. The vertical axis indicates the diffraction efficiency. In this configuration example, the diffraction efficiency increases discretely from 0.7% to 2% as the distance x from the incidence portion 2 becomes longer.

FIG. 2D is a graph indicating the correlation between the height of the diffraction grating and the diffraction efficiency. The horizontal axis indicates the height of the diffraction grating. The vertical axis indicates the diffraction efficiency. It is indicated that there is a correlation between the height of the diffraction grating and the diffraction efficiency. An arrow R indicates the range of use as the emission portion 4.

In this manner, it is possible to adjust the diffraction efficiency by varying the height of the diffraction grating of the emission portion 4. It is possible to render the light intensity of light to be emitted substantially uniform, by increasing the diffraction efficiency as the distance from the incidence portion 2 becomes longer. That is, the height of the diffraction grating can be determined such that the light intensity is substantially uniform. However, the diffraction efficiency may be increased or lowered toward the side opposite to the incidence portion 2 from substantially the center of the emission portion 4, depending on the configuration of the light guide plate 1. Therefore, the height preferably becomes greater at least toward substantially the center of the emission portion 4 from the incidence portion 2.

In this configuration example, the height of the diffraction grating is varied discretely, and therefore there is a gap at positions at which the height is varied. This gap may cause a reduction in image quality.

There also occurs a problem that the manufacturing cost increases when the height of the diffraction grating is varied discretely. Photolithography has conventionally been used to form diffraction gratings. In the photolithography, a mask is disposed on a photosensitive resin material called resist, and the resist is irradiated with light. Then, a portion of the resist irradiated with light is cured. An uncured portion of the resist is removed in a development process. A diffraction grating is formed in this manner. When the height of the diffraction grating is to be varied discretely, it is necessary to perform photolithography discretely, which increases the number of processes. When it is necessary to vary the height of a diffraction grating in n steps, for example, it is necessary to perform photolithography 2″ times.

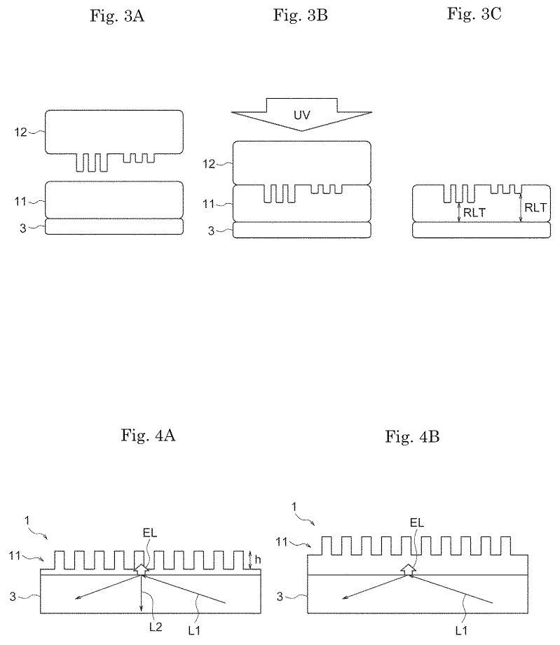

Therefore, a nanoimprint method is preferably used to form diffraction gratings. The nanoimprint method provides a high throughput and includes a small number of simple processes, and therefore can significantly reduce the manufacturing cost compared to the photolithography. The nanoimprint method will be described with reference to FIG. 3. FIG. 3 is a schematic diagram illustrating an example of a method of manufacturing the light guide plate 1 according to the embodiment of the present technique.

As illustrated in FIG. 3A, first, a resin material (resist) 11 is attached to a substrate 3. Next, as illustrated in FIG. 3B, a mold 12 is pressed against the resin material 11, and ultraviolet radiation UV is radiated to cure the resin material 11. Then, as illustrated in FIG. 3C, a diffraction grating is formed in the resin material 11. A residual layer is formed between the diffraction grating and the substrate 3. A residual layer thickness RLT as the thickness of the residual layer is varied in accordance with various parameters.

### [(3) Residual Layer Thickness]

The correlation between the residual layer thickness and the intensity of light emitted from the diffraction grating will be described with reference to FIG. 4. FIG. 4 is a simplified side view illustrating a configuration example of the light guide plate 1 according to the embodiment of the present technique. FIG. 4A illustrates a configuration example in which the residual layer thickness is designed appropriately. FIG. 4B illustrates a configuration example in which the residual layer thickness is designed inappropriately.

As illustrated in FIG. 4A, the light guide plate 1 includes a substrate 3 and a diffraction grating formed from a resin material 11 having a lower refractive index than the substrate 3.

Incident light L1 is totally reflected at the boundary surface between the substrate 3 and the resin material 11 due to the difference in the refractive index between the substrate 3 and the resin material 11. At this time, evanescent light EL indicated by an upward arrow enters the diffraction grating. This evanescent light EL and the diffraction grating interfere with each other to cause a diffraction phenomenon. Then, light L2 indicated by a downward arrow is emitted to the pupils of an observer due to this diffraction phenomenon.

The light intensity of the evanescent light EL exponentially reduces as the residual layer thickness becomes greater. Therefore, the evanescent light EL does not easily enter the diffraction grating in the configuration example illustrated in FIG. 4B in which the residual layer thickness is designed inappropriately. Therefore, there occurs a problem that no diffraction phenomenon is caused or diffraction is not caused in accordance with a design value.

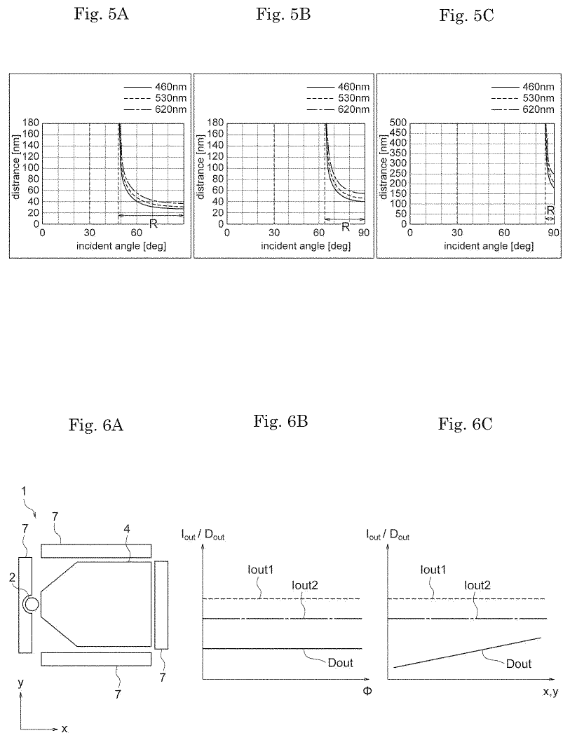

In addition, the penetration depth of evanescent light is correlated with the side-view incident angle of light. This will be described with reference to FIG. 5. FIG. 5 is a graph indicating the correlation between the penetration depth of evanescent light and the side-view incident angle of light. The horizontal axis indicates the side-view incident angle. The vertical axis indicates the penetration depth of evanescent light. In this configuration example, incident light is guided inside the substrate 3 when the side-view incident angle is 30 degrees or more.

In FIG. 5A, the refractive index of the resin material that constitutes the diffraction grating is 1.5. In FIG. 5B, the refractive index of the resin material that constitutes the diffraction grating is 1.8. In FIG. 5C, the refractive index of the resin material that constitutes the diffraction grating is 2.0. In any of FIGS. 5A to 5C, the refractive index of the substrate 3 is 2.0.

Light with a peak wavelength of 460 nm, light with a peak wavelength of 530 nm, and light with a peak wavelength of 620 nm are indicated in each of FIGS. 5A to 5C. In the range indicated by an arrow R, light is totally reflected, and therefore evanescent light is generated. The penetration depth of the evanescent light becomes smaller as the side-view incident angle becomes larger.

### [(4) Adjustment of Residual Layer Thickness]

As discussed above, the light intensity of the evanescent light EL exponentially reduces as the residual layer thickness becomes greater. Hence, the residual layer thickness is preferably determined such that the light intensity as the intensity of light emitted from the emission portion 4 is substantially uniform. The penetration depth of the evanescent light and the diffraction efficiency can be appropriately controlled by appropriately designing the residual layer thickness. As a result, the light intensity of light emitted from the emission portion 4 can be rendered substantially uniform.

The light guide plate 1 according to the embodiment of the present technique will be described with reference to FIG. 6. FIG. 6A is a simplified front view illustrating a configuration example of the light guide plate 1 according to the embodiment of the present technique. As illustrated in FIG. 6, the light guide plate 1 according to the embodiment of the present technique includes an incidence portion 2 and an emission portion 4. Return portions 7 that diffract and return light to the emission portion 4 may be disposed around the incidence portion 2 and the emission portion 4. The return portions 7 include a diffraction grating. The light guide plate 1 may not necessarily include the return portions 7.

FIGS. 6B and 6C are each a graph indicating a design example of the emission portion 4 according to the embodiment of the present technique. In FIG. 6B, the horizontal axis indicates a side-view incident angle ϕ at the time when light is incident on the substrate 3. The vertical axis indicates a light intensity Iₒᵤₜ of light emitted from the emission portion 4 or a diffraction efficiency Dₒᵤₜ of the emission portion 4. As indicated in FIG. 6B, each of a light intensity Iₒᵤₜ₁ at a predetermined pupil position and a light intensity Iₒᵤₜ₂ at a predetermined pupil position are not affected by the side-view incident angle ϕ, but are substantially uniform. In addition, the diffraction efficiency Dₒᵤₜ is not affected by the side-view incident angle ϕ, but is substantially uniform.

In FIG. 6C, the horizontal axis indicates a distance x or a distance y from the incidence portion 2. The vertical axis indicates a light intensity Iₒᵤₜ of light emitted from the emission portion 4 or a diffraction efficiency Dₒᵤₜ of the emission portion 4. As indicated in FIG. 6C, each of a light intensity Iₒᵤₜ₁ at a predetermined pupil position and a light intensity Iₒᵤₜ₂ at a predetermined pupil position are not affected by the distance from the incidence portion 2, but are substantially uniform. Meanwhile, the diffraction efficiency Dₒᵤₜ becomes higher as the distance x, y from the incidence portion 2 becomes longer.

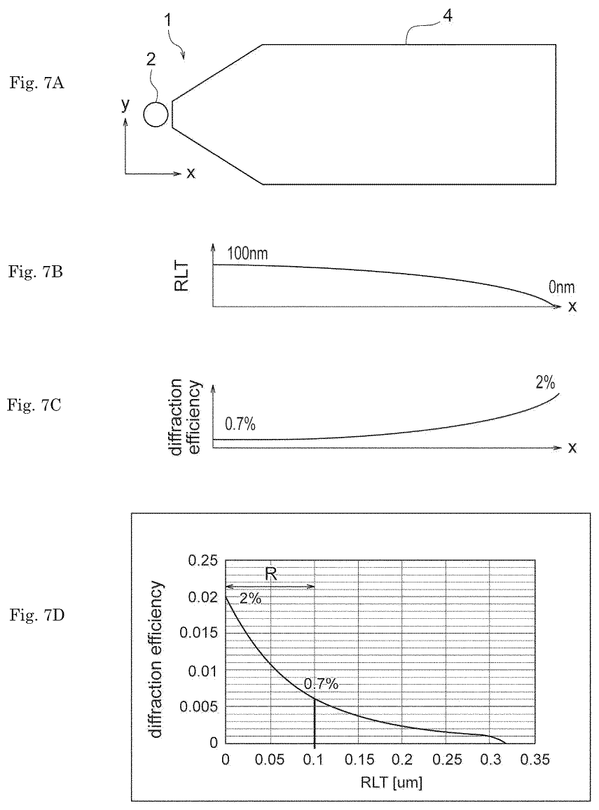

According to the present technique, such a design example can be made by appropriately designing the residual layer thickness. By rendering the diffraction efficiency Dₒᵤₜ higher as the distance x, y from the incidence portion 2 becomes longer, the light intensity of light emitted from the emission portion 4 can be rendered substantially uniform. The residual layer thickness preferably becomes smaller as the distance from the incidence portion 2 becomes longer, in order that the light intensity is substantially uniform. This will be described with reference to FIG. 7. FIG. 7 illustrates an example of the light guide plate 1 according to the embodiment of the present technique.

FIG. 7A is a simplified front view illustrating a configuration example of the example. As illustrated in FIG. 7A, the light guide plate 1 according to the example includes an incidence portion 2 and an emission portion 4.

FIG. 7B is a graph indicating how the residual layer thickness of the emission portion 4 varies. The horizontal axis indicates the distance x from the incidence portion 2. The horizontal axis corresponds to FIG. 7A. The vertical axis corresponds to the residual layer thickness. In this configuration example, the residual layer thickness reduces continuously from 100 nm to 0 nm as the distance from the incidence portion 2 becomes longer. No gap is caused since the residual layer thickness becomes continuously smaller, unlike when the height of the diffraction grating is varied discretely (see FIG. 2). Therefore, a reduction in image quality can be prevented. Further, the manufacturing cost can be considerably reduced since the nanoimprint method is used, compared to when the height of the diffraction grating is varied.

In this configuration example, the height of the diffraction grating is 100 nm. The width of the diffraction grating is 150 nm. The pitch of the diffraction grating is 320 nm. The extinction coefficient of the diffraction grating is 0. The refractive index of the diffraction grating is 1.5.

FIG. 7C is a graph indicating the diffraction efficiency obtained through simulations. The horizontal axis indicates the distance x from the incidence portion 2. The vertical axis indicates the diffraction efficiency. In this configuration example, the diffraction efficiency increases continuously from 0.7% to 2% as the distance x from the incidence portion 2 becomes longer.

FIG. 7D is a graph indicating the correlation between the residual layer thickness and the diffraction efficiency. The horizontal axis indicates the residual layer thickness. The vertical axis indicates the diffraction efficiency. It is indicated that there is a correlation between the residual layer thickness and the diffraction efficiency. An arrow R indicates the range of use as the emission portion 4.

In this manner, it is possible to adjust the diffraction efficiency by varying the residual layer thickness. The diffraction efficiency can be increased as the distance from the incidence portion 2 becomes longer, by reducing the residual layer thickness as the distance from the incidence portion 2 becomes longer. As a result, it is possible to render the light intensity of light to be emitted substantially uniform.

The diffraction efficiency becomes higher as the residual layer thickness is reduced toward substantially the center of the emission portion 4 from the incidence portion 2. However, the diffraction efficiency may be increased or lowered toward the side opposite to the incidence portion 2 from substantially the center of the emission portion 4, due to the light diffracted by the return portions 7 or the like, for example. Therefore, the residual layer thickness preferably becomes smaller at least toward substantially the center of the emission portion 4 from the incidence portion 2.

Further, as illustrated in FIG. 2, the diffraction efficiency can be increased as the distance from the incidence portion 2 becomes longer, by increasing the height of the diffraction grating as the distance from the incidence portion 2 becomes longer. Thus, not only the residual layer thickness but also the height of the diffraction grating of the emission portion 4 may be increased toward substantially the center of the emission portion 4 from the incidence portion 2. This increases the diffraction efficiency of the emission portion 4 toward substantially the center of the emission portion 4 from the incidence portion 2. As a result, the light intensity can be rendered substantially uniform.

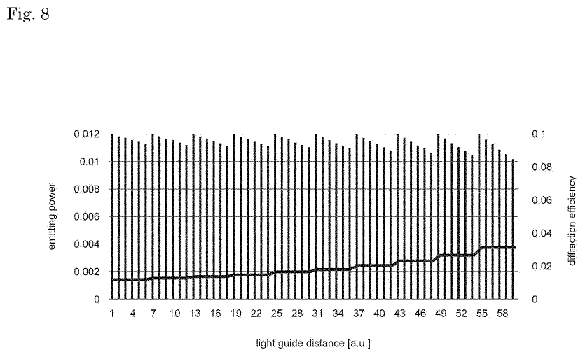

A design example of the diffraction grating will be described with reference to FIG. 8. FIG. 8 is a graph indicating a simulation result of the emission portion 4 according to the embodiment of the present technique. The horizontal axis indicates the distance from the incidence portion 2. The left vertical axis indicates the light intensity of light emitted from the emission portion 4, and corresponds to the bar graph. The right vertical axis indicates the diffraction efficiency, and corresponds to the line graph. The diffraction efficiency is designed such that the minimum value of the light intensity is −15% of the maximum value of the light intensity. As indicated in FIG. 8, the light intensity is rendered substantially uniform by appropriately designing the diffraction efficiency.

As illustrated in FIG. 6A, the light guide plate 1 may further include return portions 7 that diffract light inward of the emission portion. This makes it possible to suppress a light loss due to emission of light to the outside of the light guide plate 1, and to improve the efficiency of use of light. The return portions 7 are disposed on the outer side of a region on which light from the substrate 3 is incident, and at the outer periphery of the emission portion 4. At this time, preferably, the return portions 7 include a diffraction grating, and the residual layer thickness as the thickness of a residual layer formed between the diffraction grating of the return portions 7 and the substrate 3 is determined such that the light intensity as the intensity of light emitted from the emission portion 4 is substantially uniform. This makes it possible to appropriately adjust the diffraction efficiency, and to render the light intensity substantially uniform.

Further, the incidence portion 2 may include a diffraction grating, and the residual layer thickness as the thickness of a residual layer formed between the diffraction grating of the incidence portion 2 and the substrate 3 may be determined such that the light intensity as the intensity of light emitted from the emission portion 4 is substantially uniform. This makes it possible to appropriately adjust the diffraction efficiency, and to render the light intensity substantially uniform.

The above description of the light guide plate according to the first embodiment of the present technique can be applied to other embodiments of the present technique as long as there is no particular technical contradiction.

### 2. Second Embodiment (Example 2 of Light Guide Plate)

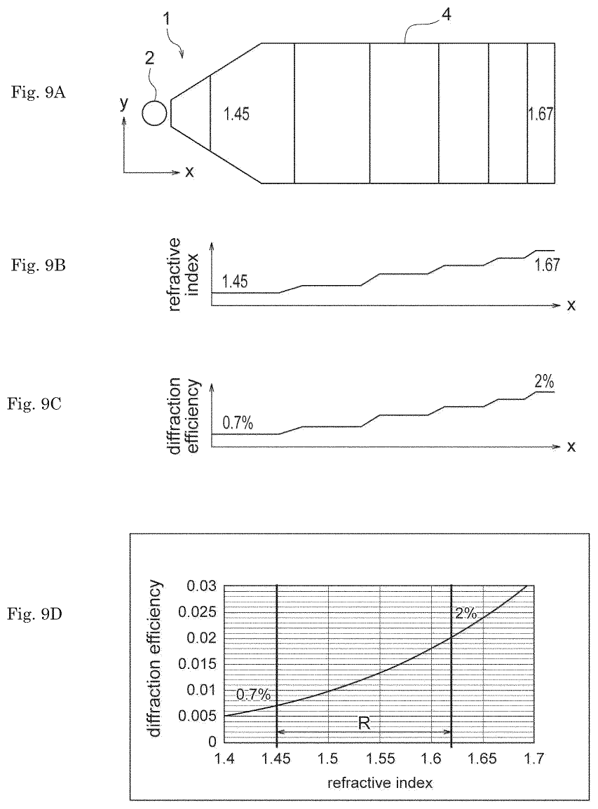

The refractive index of the diffraction grating may be determined such that the light intensity is substantially uniform. This will be described with reference to FIG. 9. FIG. 9 illustrates an example of a light guide plate 1 according to an embodiment of the present technique.

FIG. 9A is a simplified front view illustrating a configuration example of the example. As illustrated in FIG. 9A, the light guide plate 1 according to the example includes an incidence portion 2 and an emission portion 4.

FIG. 9B is a graph indicating how the refractive index of the diffraction grating of the emission portion 4 varies. The horizontal axis indicates the distance x from the incidence portion 2. The horizontal axis corresponds to FIG. 9A. The vertical axis indicates the refractive index. In this configuration example, the refractive index increases from 1.45 to 1.67 substantially discretely as the distance x from the incidence portion 2 becomes longer. Further, the refractive index varies gently at the boundary between surfaces with different refraction indices. This prevents a reduction in image quality due to a gap.

The means for varying the refractive index is not specifically limited, and a resin, metal, or the like containing nanoparticles with a high refractive index can be stacked on the diffraction grating, for example.

In this configuration example, the residual layer thickness is 60 nm. The height of the diffraction grating is 100 nm. The width of the diffraction grating is 150 nm. The pitch of the diffraction grating is 320 nm. The extinction coefficient of the diffraction grating is 0.

FIG. 9C is a graph indicating the diffraction efficiency obtained through simulations. The horizontal axis indicates the distance x from the incidence portion 2. The vertical axis indicates the diffraction efficiency. In this configuration example, the diffraction efficiency increases substantially discretely from 0.7% to 2% as the distance x from the incidence portion 2 becomes longer.

FIG. 9D is a graph indicating the correlation between the refractive index and the diffraction efficiency. The horizontal axis indicates the refractive index. The vertical axis indicates the diffraction efficiency. It is indicated that there is a correlation between the refractive index and the diffraction efficiency. An arrow R indicates the range of use as the emission portion 4.

In this manner, it is possible to adjust the diffraction efficiency by varying the refractive index. The diffraction efficiency can be increased as the distance from the incidence portion 2 becomes longer, by increasing the refractive index as the distance from the incidence portion 2 becomes longer. It is possible to render the light intensity of light to be emitted substantially uniform, by increasing the diffraction efficiency as the distance from the incidence portion 2 becomes longer.

The above description of the light guide plate according to the second embodiment of the present technique can be applied to other embodiments of the present technique as long as there is no particular technical contradiction.

### 3. Third Embodiment (Example 3 of Light Guide Plate)

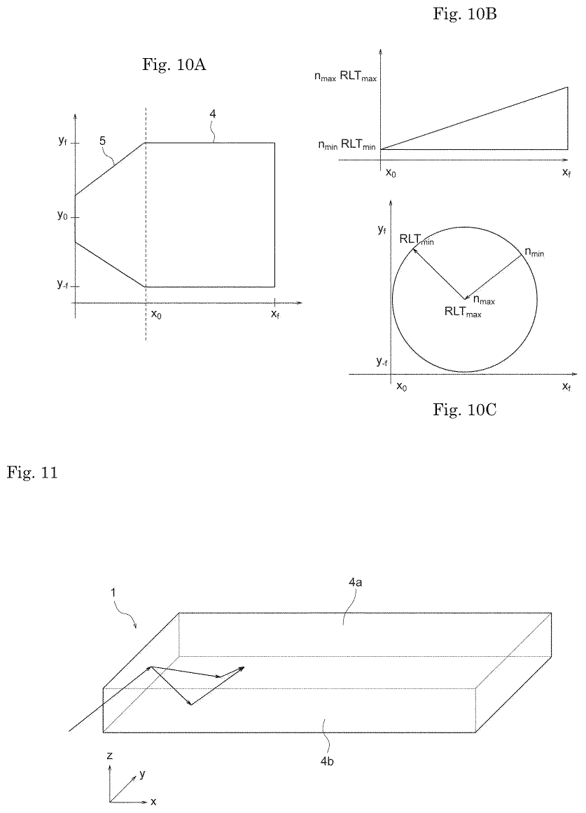

One or more kinds selected from the group consisting of the residual layer thickness, the refractive index of the diffraction grating, and the height of the diffraction grating are preferably determined such that the light intensity is substantially uniform. That is, the diffraction efficiency is preferably adjusted by varying the residual layer thickness, the refractive index of the diffraction grating, and the height of the diffraction grating in combination with each other. This will be described with reference to FIG. 10. FIG. 10 illustrates an example of an emission portion 4 according to an embodiment of the present technique.

FIG. 10A is a simplified front view illustrating a configuration example of the emission portion 4 according to the embodiment of the present technique. FIG. 10A illustrates the emission portion 4 and an expansion portion 5 that diffracts light guided by the substrate 3 toward the emission portion 4 and expands the light in the vertical direction in FIG. 10A. The expansion portion 5 may not necessarily be included in the light guide plate 1.

In FIG. 10A, the horizontal axis is an x-axis, and the vertical axis is a y-axis. The emission portion 4 is formed in a rectangular shape, for example. The emission portion 4 is formed in the range of x₀ to x_{f} in the x-axis direction, and formed in the range of y_{-f} to y_{f} in the y-axis direction. The expansion portion 5 is formed in a trapezoidal shape, for example. The expansion portion 5 is formed in the range of 0 to x₀ in the x-axis direction, and formed in the range of y_{-f} to y_{f} in the y-axis direction.

FIG. 10B is a graph indicating a design example of the emission portion 4 illustrated in FIG. 10A. The horizontal axis of FIG. 10B corresponds to the horizontal axis of FIG. 10A. The vertical axis of FIG. 10B indicates a refractive index n of the diffraction grating of the emission portion 4, and a residual layer thickness RLT as the thickness of the residual layer formed on the emission portion 4. As indicated in FIG. 10B, the residual layer thickness RLT preferably becomes greater as the distance from the incidence portion 2 becomes longer. Additionally, the refractive index n preferably becomes higher as the distance from the incidence portion 2 becomes longer. This increases the diffraction efficiency of the emission portion 4 toward substantially the center of the emission portion 4 from the incidence portion 2. As a result, the light intensity can be rendered substantially uniform.

The diffraction efficiency becomes higher as the residual layer thickness is reduced toward substantially the center of the emission portion 4 from the incidence portion 2. Similarly, the diffraction efficiency becomes higher as the refractive index n is increased toward substantially the center of the emission portion 4 from the incidence portion 2. However, the diffraction efficiency may be increased or lowered toward the side opposite to the incidence portion 2 from substantially the center of the emission portion 4, due to the light diffracted by the return portions 7 illustrated in FIG. 6A or the like, for example. Therefore, the residual layer thickness RLT preferably becomes greater at least toward substantially the center of the emission portion 4 from the incidence portion 2. Additionally, the refractive index n preferably becomes higher toward substantially the center of the emission portion 4 from the incidence portion 2.

Further, as illustrated in FIG. 2, the diffraction efficiency can be increased as the distance from the incidence portion 2 becomes longer, by increasing the height of the diffraction grating as the distance from the incidence portion 2 becomes longer. Thus, not only the residual layer thickness RLT and the refractive index n but also the height of the diffraction grating of the emission portion 4 may be increased toward substantially the center of the emission portion 4 from the incidence portion 2. This increases the diffraction efficiency of the emission portion 4 toward substantially the center of the emission portion 4 from the incidence portion 2. As a result, the light intensity can be rendered substantially uniform.

FIG. 10 is referred back to for description. FIG. 10C is a graph indicating a design example of the emission portion 4 illustrated in FIG. 10A. The horizontal axis of FIG. 10C corresponds to the horizontal axis of FIG. 10A. The vertical axis of FIG. 10C corresponds to the vertical axis of FIG. 10A. In FIG. 10C, RLTₘₐₓ indicates a position at which the residual layer thickness RLT is greatest. RLTₘᵢₙ indicates a position at which the residual layer thickness RLT is smallest. nₘₐₓ indicates a position at which the refractive index n is greatest. nₘᵢₙ indicates a position at which the refractive index n is smallest.

As indicated in FIG. 10C, the residual layer thickness RLT preferably becomes greater toward substantially the center of the emission portion 4 from the incidence portion 2. Additionally, the refractive index n preferably becomes higher toward substantially the center of the emission portion 4 from the incidence portion 2.

Further, the residual layer thickness RLT preferably becomes smaller toward the side opposite to the incidence portion 2 from substantially the center of the emission portion 4. This increases the diffraction efficiency of the emission portion 4 toward the side opposite to the incidence portion 2 from substantially the center of the emission portion 4. As a result, the light intensity can be rendered substantially uniform. At this time, the refractive index n and the height of the diffraction grating may be increased, or may be reduced, toward the side opposite to the incidence portion 2 from substantially the center of the emission portion 4.

The expansion portion 5 may include a diffraction grating, and the residual layer thickness as the thickness of a residual layer formed between the diffraction grating of the expansion portion 5 and the substrate 3 may be determined such that the light intensity as the intensity of light emitted from the emission portion 4 is substantially uniform. This increases the diffraction efficiency of the emission portion 4 toward substantially the center of the emission portion 4 from the incidence portion 2. As a result, the light intensity can be rendered substantially uniform.

The above description of the light guide plate according to the third embodiment of the present technique can be applied to other embodiments of the present technique as long as there is no particular technical contradiction.

### 4. Fourth Embodiment (Example 4 of Light Guide Plate)

If the residual layer thickness exceeds a predetermined range, lights diffracted within the surface of the emission portion 4 may interfere with each other to cause a reduction in image quality. This will be described with reference to FIG. 11. FIG. 11 is a simplified perspective view illustrating how light is guided inside a light guide plate 1 according to an embodiment of the present technique.

Light incident into the light guide plate 1 is diffracted by a diffraction grating of an emission portion 4a disposed on the upper surface of the light guide plate 1 to be branched into light on the positive side of the y-axis and light on the negative side of the y-axis. The respective lights branched are diffracted by a diffraction grating of an emission portion 4b disposed on the lower surface of the light guide plate 1 to be merged with each other. This phenomenon occurs when the sum of the grating vector of the incidence portion 2 and the basic grating vector of the emission portion 4 is 0 to be closed.

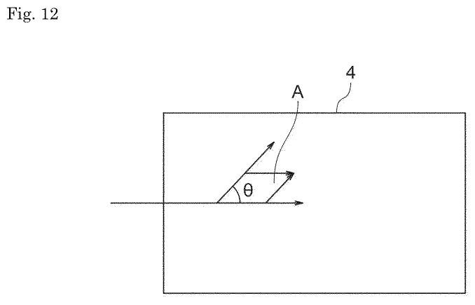

FIG. 12 illustrates the phenomenon as seen from the upper side. FIG. 12 is a simplified front view illustrating how light is guided inside the light guide plate 1 according to the embodiment of the present technique. A region A interposed between two light paths has the function of a so-called Mach-Zehnder interferometer. If the residual layer thickness in the region A is more than a predetermined range, a light path difference is caused between the two light paths. This causes interference between the lights. Therefore, the residual layer thickness in the region A is preferably within the predetermined range. That is, the residual layer is preferably formed such that the path lengths for two lights from the point at which light is diffracted by the diffraction grating into two lights to the point at which the two lights are merged with each other are substantially equal.

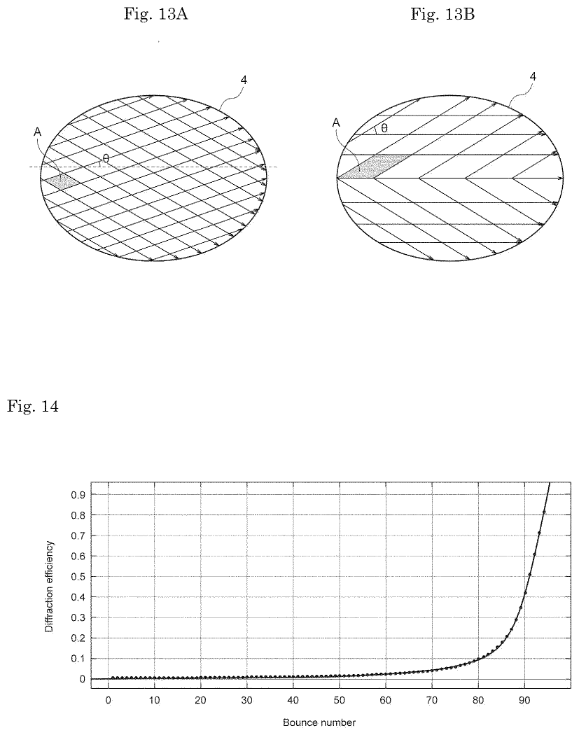

The shape of the region A varies variously in accordance with the light paths of the lights. This will be described with reference to FIG. 13. FIG. 13 is a simplified front view illustrating how light is guided inside an emission portion 4 according to the embodiment of the present technique. The shape of the emission portion 4 is not specifically limited. As illustrated in FIG. 13, the light paths for lights to be guided and the shape of the region A vary in accordance with the design of the diffraction grating.

When light abuts against a diffraction grating to be diffracted, the light is “bounced”. Each time light is bounced, the light is emitted to the outside of the light guide plate 1, which decreases the light intensity. Therefore, the light intensity of light to be emitted to the pupils of an observer can be defined in accordance with the number of bounces. When the area of the region A is defined as s1 and the area of the entire emission portion 4 is defined as s2, a number n_{bou} of bounces meets a mathematical expression indicated by the formula (1).

$${n}_{bou} = s 2 / s 1 \qquad ( 1 )$$

A maximum value Max(Iₒᵤₜ) of the light intensity Iₒᵤₜ of light to be emitted to the pupils of an observer meets a mathematical expression indicated by the formula (2).

$$Max ( {I}_{out} ) < 100 / {n}_{bou} \qquad ( 2 )$$

The diffraction efficiency is preferably designed such that the light intensity Iₒᵤₜ is substantially uniform within the surface of the emission portion 4. The correlation between the number n_{bou} of bounces and the diffraction efficiency will be described with reference to FIG. 14. FIG. 14 is a graph indicating the correlation between a number n_{bou} of bounces and the diffraction efficiency. The horizontal axis indicates the number n_{bou} of bounces. The vertical axis indicates the diffraction efficiency. A position at which incident light is first bounced is defined as the origin.

As indicated in FIG. 14, the diffraction efficiency increases as the number n_{bou} of bounces increases. Thus, the light intensity Iₒᵤₜ can be rendered substantially uniform within the surface of the emission portion 4 by varying the diffraction efficiency in accordance with the position at which light is bounced.

When the distance from the incidence portion 2 is defined as r and the side-view incident angle is defined as ϕ, a diffraction efficiency Dₒᵤₜ at polar coordinates (r, ϕ) meets a mathematical expression indicated by the formula (3). aₙ, bₙ, and cₙ are each a function of the side-view incident angle ϕ.

$$\begin{matrix}[ Math . 1 ] & \\ {D}_{out} ( r , φ ) = {\sum }_{n = 1}^{m} ( - {a}_{n} ( φ ) * {exp ( \frac{r - {b}_{n} ( φ )}{{c}_{n} ( φ )} )}^{2} ) . & ( 3 )\end{matrix}$$

As discussed above, when a light path difference is caused between two light paths, the lights interfere with each other. In order to prevent such interference, the residual layer is preferably formed such that the path lengths for two lights from the point at which light is diffracted by the diffraction grating into two lights to the point at which the two lights are merged with each other meet a mathematical expression indicated by the formula (4). The thickness of the residual layer is preferably in a predetermined range. When the wavelength of incident light is defined as λ, the side-view incident angle is defined as ϕ, the refractive index of the diffraction grating is defined as n, and the allowable residual layer thickness is defined as Δt, a wavelength Δλ at which no interference is caused preferably meets the mathematical expression indicated by the formula (4).

$$Δ λ = 2 n Δ t / cos ϕ < λ / 4 \qquad ( 4 )$$

That is, preferably, the path lengths for two lights from the point at which light is diffracted by the diffraction grating into two lights to the point at which the two lights are merged with each other meet a mathematical expression indicated by the formula (5), and when the wavelength of incident light is defined as λ, the side-view incident angle is defined as ϕ, and the refractive index of the diffraction grating is defined as n, the allowable residual layer thickness Δt meets the mathematical expression indicated by the formula (5).

$$Δ t < λ cos ϕ / 4 n \qquad ( 5 )$$

Further, the allowable residual layer thickness Δt preferably meets a mathematical expression indicated by the formula (6).

$$Δ t < λcosϕ / 8 n \qquad ( 6 )$$

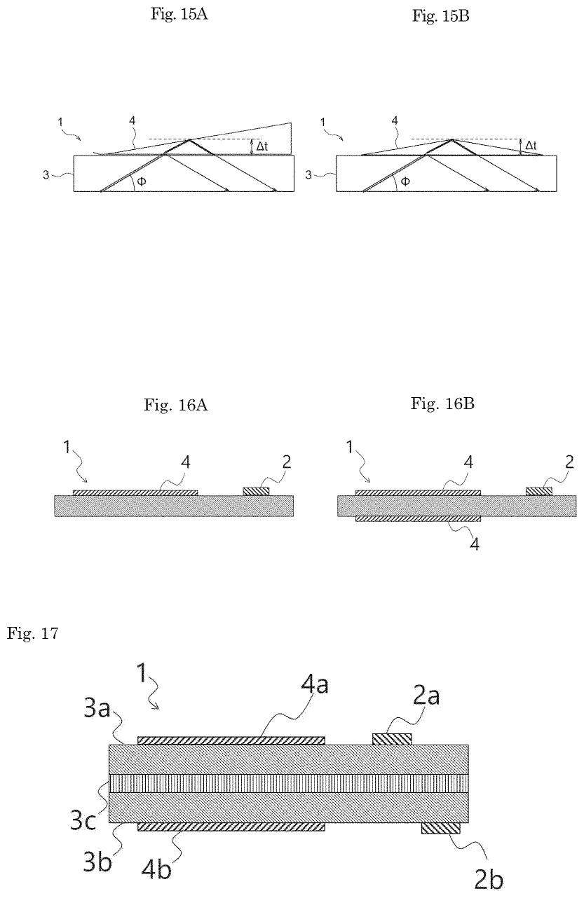

The allowable residual layer thickness Δt is defined without depending on the shape of the emission portion 4. This will be described with reference to FIG. 15. FIG. 15 is a simplified side view illustrating a configuration example of the light guide plate 1 according to the embodiment of the present technique. In FIG. 15A, the height of the emission portion 4 becomes higher from the left side toward the right side. In FIG. 15B, the height of the emission portion 4 becomes higher and thereafter becomes lower from the left side toward the right side. The allowable residual layer thickness Δt can be defined in both the configuration example illustrated in FIG. 15A and the configuration example illustrated in FIG. 15B.

In order not to cause interference between lights, the residual layer thickness preferably varies gently in the range of 5 nm to 500 nm. More preferably, the residual layer thickness varies gently in the range of 10 nm to 200 nm. The refractive index of the diffraction grating is preferably in the range of 1.4 to 2.2. More preferably, the refractive index of the diffraction grating is in the range of 1.5 to 1.85. When the diffraction efficiency varies continuously, the maximum value of the diffraction efficiency may be 100%. The minimum value of the diffraction efficiency decreases in accordance with the number of bounces and the diffraction efficiency (see FIG. 14). When the diffraction efficiency varies discretely, the diffraction efficiency is preferably less than 10%. More preferably, the diffraction efficiency is less than 3%.

The above description of the light guide plate according to the fourth embodiment of the present technique can be applied to other embodiments of the present technique as long as there is no particular technical contradiction.

### 5. Fifth Embodiment (Example 5 of Light Guide Plate)

The emission portion 4 may be disposed on one or both surfaces of the light guide plate 1. This will be described with reference to FIG. 16. FIG. 16 is a simplified side cross-sectional view illustrating a configuration example of a light guide plate 1 according to an embodiment of the present technique.

As illustrated in FIG. 16A, the emission portion 4 may be disposed on only one surface of the light guide plate 1. This simplifies the manufacturing process, and reduces the manufacturing cost.

As illustrated in FIG. 16B, the emission portion 4 may be disposed on both surfaces of the light guide plate 1. This increases the degree of freedom in design. As a result, it is possible to improve the efficiency of use of light, improve brightness distribution, and so forth. For example, it is possible for the emission portion 4 disposed on one surface to control the direction in which light is led into the light guide plate 1, and for the emission portion 4 disposed on the other surface to emit light to the pupils of an observer. The light guide plate 1 can emit light in a single color with a single wavelength and light in a plurality of colors with different wavelengths to the pupils of an observer.

The positions at which the incidence portion 2 and the emission portion 4 are disposed are not limited. The incidence portion 2 and the emission portion 4 may be disposed on the same surface, or may be disposed on different surfaces. The incidence portion 2 and the emission portion 4 are disposed at different positions in accordance with whether a transmissive diffraction grating is used or whether a reflective diffraction grating is used. The incidence portion 2 also may be disposed on one or both surfaces of the light guide plate 1.

The above description of the light guide plate according to the fifth embodiment of the present technique can be applied to other embodiments of the present technique as long as there is no particular technical contradiction.

### 6. Sixth Embodiment (Example 6 of Light Guide Plate)

A light guide plate 1 may include one or a plurality of incidence portions 2 and one or a plurality of emission portions 4. This will be described with reference to FIG. 17. FIG. 17 is a simplified side cross-sectional view illustrating a configuration example of a light guide plate 1 according to an embodiment of the present technique.

As illustrated in FIG. 17, the light guide plate 1 may include a plurality of incidence portions 2a, 2b and a plurality of emission portions 4a, 4b. Although not illustrated, a plurality of light guide plates 1 may be provided. In this configuration example, the incidence portion 2a and the emission portion 4a are disposed on the surface of a substrate 3a. An emission portion 4b is disposed on the surface of a substrate 3b. Substrates 3a, 3c, 3b are disposed and stacked in this order. The substrates 3a, 3b can contain a material with a high refractive index, and the substrate 3c can contain a material with a low refractive index, for example. With such a configuration example, the light guide plate 1 can emit lights in a plurality of colors with different wavelengths to the pupils of an observer. As a result, it is possible to colorize light and widen the angle of view of light. The positions of the incidence portions 2a, 2b in the longitudinal direction of the light guide plate 1 may be the same as or different from each other. When the positions of the incidence portions 2a, 2b are different, lights in a plurality of colors with different wavelengths are incident at different positions. As a result, the occurrence of crosstalk can be reduced.

The positions at which the incidence portion 2 and the emission portion 4 are disposed and the respective numbers of light guide plates 1, incidence portions 2, and emission portions 4 are not limited to those according to the above configuration examples. The above configuration examples can be combined with each other.

The above description of the light guide plate according to the sixth embodiment of the present technique can be applied to other embodiments of the present technique as long as there is no particular technical contradiction.

### 7. Seventh Embodiment (Example 7 of Light Guide Plate)

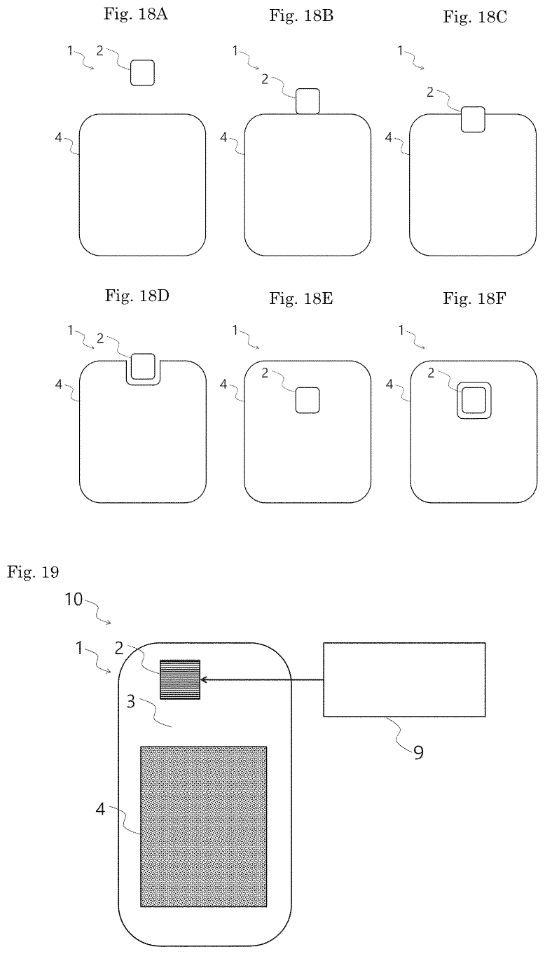

The positions at which the incidence portion 2 and the emission portion 4 are disposed are not specifically limited. This will be described with reference to FIG. 18. FIG. 18 is a simplified front view illustrating a configuration example of an incidence portion 2 and an emission portion 4 according to an embodiment of the present technique.

As in configuration examples illustrated in FIGS. 18A, 18D, and 18F, the incidence portion 2 and the emission portion 4 may be disposed away from each other. The incidence portion 2 may be disposed inside the emission portion 4.

Alternatively, as in configuration examples illustrated in FIGS. 18B, 18C, and 18E, the incidence portion 2 and the emission portion 4 may be disposed in contact with each other. The incidence portion 2 may be disposed inside the emission portion 4.

The above description of the light guide plate according to the seventh embodiment of the present technique can be applied to other embodiments of the present technique as long as there is no particular technical contradiction.

### 8. Eighth Embodiment (Example of Image Display Device)

The present technique provides an image display device including a light guide plate according to the first to sixth embodiments and an image formation unit that emits image light to the light guide plate. This will be described with reference to FIG. 19. FIG. 19 is a block diagram illustrating a configuration example of an image display device 10 according to an embodiment of the present technique. As illustrated in FIG. 19, an image display device 10 according to the embodiment of the present technique includes a light guide plate 1 and an image formation unit 9 that emits image light to the light guide plate 1.

The image formation unit 9 forms image light. The image formation unit 9 can use a micro panel to form an image in the image formation unit 9. This micro panel may be a self-luminous panel such as a micro LED or a micro OLED, for example. A reflective or transmissive liquid crystal may be used to use an LED (Light Emitting Diode) light source or an LD (Laser Diode) light source in combination with an illumination optical system.

The image light emitted from the image formation unit 9 is converted into substantially parallel light by a projection lens (not illustrated) or the like, for example, and concentrated on the incidence portion 2 to be incident on the light guide plate 1. The incidence portion 2 may be disposed on the image formation unit 9 side, or may be on the side opposite to the image formation unit 9 side.

The image display device 10 may be a head mounted display (HMD) to be worn on a head portion of a user. Alternatively, the image display device 10 may be disposed at a predetermined location as an infrastructure.

The above description of the image display device according to the eighth embodiment of the present technique can be applied to other embodiments of the present technique as long as there is no particular technical contradiction.

Note that the embodiment of the present technique is not limited to the embodiments mentioned above, and various modifications can be made without departing from the gist of the present technique.

In addition, the present technology can also have the following configurations.

[1]

A light guide plate including:
an incidence portion that diffracts incident light into the light guide plate;
a substrate that internally totally reflects the light diffracted into the light guide plate by the incidence portion and guides the light; and
an emission portion that diffracts the light guided by the substrate and emits the light to a pupil of an observer, in which:
the emission portion includes a diffraction grating; and
a residual layer thickness as a thickness of a residual layer formed between the diffraction grating of the emission portion and the substrate is determined such that a light intensity as an intensity of the light emitted from the emission portion is substantially uniform.
   [2]

The light guide plate according to [1], in which
a refractive index of the diffraction grating is determined such that the light intensity is substantially uniform.
   [3]

The light guide plate according to [2], in which
the refractive index becomes higher toward substantially a center of the emission portion from the incidence portion.
   [4]

The light guide plate according to any one of [1] to [3], in which a height of the diffraction grating is determined such that the light intensity is substantially uniform.

[5]

The light guide plate according to claim 4, in which the height becomes higher toward substantially a center of the emission portion from the incidence portion.

[6]

The light guide plate according to any one of [1] to [5], in which the residual layer thickness becomes smaller toward substantially a center of the emission portion from the incidence portion.

[7]

The light guide plate according to [6], in which a height of the diffraction grating becomes higher toward substantially the center of the emission portion from the incidence portion.

[8]

The light guide plate according to any one of [1] to [7], in which
the residual layer thickness becomes greater toward substantially a center of the emission portion from the incidence portion.
   [9]

The light guide plate according to [8], in which
the refractive index becomes higher toward substantially the center of the emission portion from the incidence portion.
   [10]

The light guide plate according to [8] or [9], in which
a height of the diffraction grating becomes higher toward substantially the center of the emission portion from the incidence portion.
   [11]

The light guide plate according to any one of [1] to [10], in which
the residual layer thickness becomes smaller toward a side opposite to the incidence portion from substantially the center of the emission portion.
   [12]

The light guide plate according to any one of [1] to [11], in which:
path lengths for two lights from a point at which light is diffracted by the diffraction grating into two lights to a point at which the two lights are merged with each other meet a mathematical expression indicated by the formula (5); and
when a wavelength of the incident light is defined as λ, a side-view incident angle is defined as ϕ, and a refractive index of the diffraction grating is defined as n, an allowable residual layer thickness Δt meets the mathematical expression indicated by the formula (5).

$$Δ t < λ cos ϕ / 4 n \qquad ( 5 )$$

[13]

The light guide plate according to [12], in which
the allowable residual layer thickness Δt meets a mathematical expression indicated by the formula (6).

$$Δ t < λcosϕ / 8 n \qquad ( 6 )$$

[14]

The light guide plate according to any one of [1] to [13], further including
an expansion portion that diffracts the light guided by the substrate toward the emission portion and expands the light, in which:
the expansion portion includes a diffraction grating; and
a residual layer thickness as a thickness of a residual layer formed between the diffraction grating of the expansion portion and the substrate is determined such that a light intensity as an intensity of the light emitted from the emission portion is substantially uniform.
   [15]

The light guide plate according to any one of [1] to [14], further including a return portion that diffracts the light inward of the emission portion, in which:
the return portion is disposed on an outer side of a region on which light from the substrate is incident, and at an outer periphery of the emission portion;
the return portion includes a diffraction grating; and
a residual layer thickness as a thickness of a residual layer formed between the diffraction grating of the return portion and the substrate is determined such that a light intensity as an intensity of the light emitted from the emission portion is substantially uniform.
   [16]

The light guide plate according to any one of [1] to [15], in which:
the incidence portion includes a diffraction grating; and
a residual layer thickness as a thickness of a residual layer formed between the diffraction grating of the incidence portion and the substrate is determined such that a light intensity as an intensity of the light emitted from the emission portion is substantially uniform.
   [17]

The light guide plate according to any one of [1] to [16], in which the emission portion is disposed on one or both surfaces of the light guide plate.

[18]

The light guide plate according to any one of [1] to [17], including:
one or a plurality of incidence portions; and
one or a plurality of emission portions.
   [19]

An image display device including:
the light guide plate according to any one of [1] to [18]; and
an image formation unit that emits image light to the light guide plate.

### REFERENCE SIGNS LIST

1 Light guide plate
2 Incidence portion
3 Substrate
4 Emission portion
7 Return portion
9 Image formation unit
10 Image display device
RLT Residual layer thickness

What is claimed is:

1. A light guide plate, comprising:
an incidence portion that diffracts incident light into the light guide plate;
a substrate that internally totally reflects the light diffracted into the light guide plate by the incidence portion and guides the light; and
an emission portion that diffracts the light guided by the substrate and emits the light to a pupil of an observer, wherein:
the emission portion includes a diffraction grating; and
a residual layer thickness as a thickness of a residual layer formed between the diffraction grating of the emission portion and the substrate is determined such that a light intensity as an intensity of the light emitted from the emission portion is substantially uniform.

2. The light guide plate according to claim 1, wherein
a refractive index of the diffraction grating is determined such that the light intensity is substantially uniform.

3. The light guide plate according to claim 2, wherein
the refractive index becomes higher toward substantially a center of the emission portion from the incidence portion.

4. The light guide plate according to claim 1, wherein
a height of the diffraction grating is determined such that the light intensity is substantially uniform.

5. The light guide plate according to claim 4, wherein
the height becomes higher toward substantially a center of the emission portion from the incidence portion.

6. The light guide plate according to claim 1, wherein
the residual layer thickness becomes smaller toward substantially a center of the emission portion from the incidence portion.

7. The light guide plate according to claim 6, wherein
a height of the diffraction grating becomes higher toward substantially the center of the emission portion from the incidence portion.

8. The light guide plate according to claim 1, wherein
the residual layer thickness becomes greater toward substantially a center of the emission portion from the incidence portion.

9. The light guide plate according to claim 8, wherein
the refractive index becomes higher toward substantially the center of the emission portion from the incidence portion.

10. The light guide plate according to claim 8, wherein
a height of the diffraction grating becomes higher toward substantially the center of the emission portion from the incidence portion.

11. The light guide plate according to claim 8, wherein
the residual layer thickness becomes smaller toward a side opposite to the incidence portion from substantially the center of the emission portion.

12. The light guide plate according to claim 1, wherein:
path lengths for two lights from a point at which light is diffracted by the diffraction grating into two lights to a point at which the two lights are merged with each other meet a mathematical expression indicated by the formula (5); and
when a wavelength of the incident light is defined as λ, a side-view incident angle is defined as ϕ, and a refractive index of the diffraction grating is defined as n, an allowable residual layer thickness Δt meets the mathematical expression indicated by the formula (5).
Δt<λ cos ϕ/4n (5)

13. The light guide plate according to claim 12, wherein
the allowable residual layer thickness Δt meets a mathematical expression indicated by the formula (6).
Δt<Δ cos ϕ/8n (6)

14. The light guide plate according to claim 1, further comprising
an expansion portion that diffracts the light guided by the substrate toward the emission portion and expands the light, wherein:
the expansion portion includes a diffraction grating; and
a residual layer thickness as a thickness of a residual layer formed between the diffraction grating of the expansion portion and the substrate is determined such that a light intensity as an intensity of the light emitted from the emission portion is substantially uniform.

15. The light guide plate according to claim 1, further comprising
a return portion that diffracts the light inward of the emission portion, wherein:
the return portion is disposed on an outer side of a region on which light from the substrate is incident, and at an outer periphery of the emission portion;
the return portion includes a diffraction grating; and
a residual layer thickness as a thickness of a residual layer formed between the diffraction grating of the return portion and the substrate is determined such that a light intensity as an intensity of the light emitted from the emission portion is substantially uniform.

16. The light guide plate according to claim 1, wherein:
the incidence portion includes a diffraction grating; and
a residual layer thickness as a thickness of a residual layer formed between the diffraction grating of the incidence portion and the substrate is determined such that a light intensity as an intensity of the light emitted from the emission portion is substantially uniform.

17. The light guide plate according to claim 1, wherein
the emission portion is disposed on one or both surfaces of the light guide plate.

18. The light guide plate according to claim 1, comprising:
one or a plurality of incidence portions; and
one or a plurality of emission portions.

19. An image display device, comprising:
the light guide plate according to claim 1; and
an image formation unit that emits image light to the light guide plate.
